(19) United States
(12) Patent Application Publication
(10) Pub. No.: US 2011/0173021 A1
(43) Pub. Date: Jul. 14, 2011

(54) AUTOMATED METHOD OF DISPLAYING AND UPDATING THE STATUS OF CLINICAL RESEARCH SITES IN A CLINICAL TRIAL TO IDENTIFY READINESS OF SITES TO ACCEPT PATIENTS

(75) Inventors: John W. HOURIET, JR., Yardley, PA (US); Patrick S. ZBYSZEWSKI, Phoenixville, PA (US); Allan D. HORWITZ, Philadelphia, PA (US); Ambalavanan SUBBIAH, Monmouth Junction, NJ (US)

(73) Assignee: NUMODA TECHNOLOGIES, INC., Philadelphia, PA (US)

(21) Appl. No.: 12/967,626

(22) Filed: Dec. 14, 2010

Related U.S. Application Data
(60) Provisional application No. 61/293,313, filed on Jan. 8, 2010.

(51) Int. Cl. G06Q 50/00; G06Q 10/00

(52) U.S. Cl. 705/2

(57) ABSTRACT

An automated process generates a displayable report of the status of clinical research sites in a clinical trial to identify readiness of sites to accept patients. The clinical trial has a plurality of sites in multiple countries which accept patients. A plurality of electronically tracked site-based milestones and separate country-based milestones are provided for the clinical trial. Each site is associated with a country. The status of the site-based milestones and country-based milestones are electronically tracked in a database. The site-based milestones and the country-based milestones are tracked separately from each other. A displayable report of the status of the electronically tracked site-based milestones and country-based milestones is automatically generated in a processor. The report separately identifies the status of the site-based milestones and the country-based milestones. Also, each site-based milestone is categorized into one of the plurality of milestone groups, and the report shows the status of the site-based milestone groups.

### CROSS-REFERENCE TO RELATED APPLICATIONS

This application claims priority to U.S. Provisional Patent Application No. 61/293,313 filed Jan. 8, 2010.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Clinical trials are conducted to collect safety and efficacy data for new drugs or devices that a company wishes to make available to the public. A typical clinical trial for a new drug is performed by having a plurality of clinical research sites administer the drug to a plurality of patients who are screened and then enrolled at the respective sites. Each site is managed by a local site clinical investigator, who is typically a physician. A principal investigator or lead investigator is in charge of the clinical trial. Most countries heavily regulate clinical trials and do not permit sites to accept patients until a list of requirements are met. Such requirements are often referred to as tasks or milestones, used interchangeably herein. (Tasks and milestones are also referred to in the context of performing the clinical trial which occurs after a site is deemed ready to accept patients.) Milestones for preparing a site to accept patients can be site-based or country-based. That is, there may be certain country-based milestones that must be met before any site within a particular country can begin to accept patients. In addition, individual sites have their own site-based milestones that must be met before the respective site can begin to accept patients. Many clinical trials today have sites and personnel spread across many different countries.

It is important to carefully track milestones so that sites can begin to accept patients as soon as possible. Once a site can begin to accept patients, the site can begin to screen and enroll patients. The present invention provides a system for tracking and communicating milestone information to key personnel, thereby improving the efficiency of the site readiness process.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIGS. 1-3 are database tables for implementing one preferred embodiment of the present invention.

FIGS. 4-5 are flowcharts for implementing one preferred embodiment of the present invention.

FIGS. 6A, 6B and 7-14 are user interface display screens in accordance with preferred embodiments of the present invention.

FIG. 15 is a list of classes in a dynamic linked library (DLL) in one preferred embodiment of the present invention.

FIG. 16 is a schematic diagram of a hardware configuration in accordance with one preferred embodiment of the present invention.

FIGS. 17-18 are user interface display screens for performing batch updating in accordance with preferred embodiments of the present invention.

FIG. 19 is a sample site completion electronic alert message in accordance with preferred embodiments of the present invention.

### DETAILED DESCRIPTION OF THE INVENTION

Certain terminology is used herein for convenience only and is not to be taken as a limitation on the present invention.

This patent application includes an Appendix having a file named appendix10001-39U1.txt, created on Nov. 4, 2010, and having a size of 95,438 bytes. The Appendix is incorporated by reference into the present patent application. One preferred embodiment of the present invention is implemented via the source code in the Appendix. The Appendix is subject to the “Copyright Notice and Authorization” stated above.

The present invention is described in the context of features provided in a web-based commercially available product called Site Launch Logistics System™ (SLLS) marketed by Numoda Corporation (Numoda), Philadelphia, Pa. In the present invention, Numoda functions as a service provider for hosting the SLLS.

### I. Overview of System

One preferred embodiment of the present invention provides an automated method of displaying the status of clinical research sites in a clinical trial to identify readiness of sites to accept patients. In this embodiment, the clinical trial has a plurality of sites in multiple countries which accept patients. The method operates as follows:

1. A plurality of electronically tracked site-based milestones and separate country-based milestones are provided for the clinical trial. Each site is associated with a country.
2. The status of the site-based milestones and country-based milestones are tracked in a database.
3. A report of the status of the electronically tracked site-based milestones and country-based milestones is automatically generated in a processor.

There may be a plurality of site-based milestone groups. If so, each site-based milestone is categorized into one of the plurality of milestone groups. The milestones in each milestone group preferably have closely related functions.

A country status may also be electronically tracked for each country that has at least one site in the clinical trial. The country status is either “complete” or “incomplete.” The country status is complete if all of the respective country-based milestones are completed. Also, a site status is electronically tracked for each site. The site status may be complete, closed, pending, or on hold. The site status is complete if all of the respective site-based milestones and the respective country-based milestones are completed. Thus, a site in country X that has completed all of its site-based milestones still cannot accept patients if there is even one uncompleted country-based milestone for country X. Some countries will not have country-based milestones. For example, there are typically no U.S. country-based milestones. Country-based milestones are common in non-U.S. countries. A site that has completed its site-based milestones in a country that has completed its country-based milestones (if any) is ready to accept patients. The site can then begin the screening and enrollment process.

Another preferred embodiment of the present invention provides an automated method of displaying the status of clinical research sites in a clinical trial to identify readiness of sites to accept patients, wherein each site-based milestone is categorized into one of a plurality of milestone groups. Again, the milestones in each milestone group preferably have closely related functions and the clinical trial has a plurality of sites which accept patients. There may be only one country in the clinical trial, or there may be a plurality of countries in the clinical trial. The method operates as follows:

1. A plurality of electronically tracked site-based milestones and a plurality of site-based milestone groups are provided for the clinical trial. As stated above, each site-based milestone is categorized into one of the plurality of milestone groups.
2. The status of the site-based milestones are electronically tracked in a database. The site-based milestones and the country-based milestones are tracked separately from each other.
3. A report of the status of the electronically tracked site-based milestones and site-based milestone groups is automatically generated in a processor for the country in the clinical trial (if there is only one country), or for the plurality of countries in the clinical trial (if there are multiple countries in the clinical trial).

Each milestone is assigned to one of a plurality of owners. Each owner has unique login credentials for viewing a display of the status of clinical research sites and generating the report. Each milestone includes a status of being complete. The processor is used to identify the logged in owner based on entered login credentials, and to identify site-based milestone groups that have milestones with a status of not being complete. The report includes an identifier associated with any milestone groups that have milestones with a status of not being complete for the logged in owner. The reports shown in the examples below use bolding, italics and/or daggers as identifiers.

Another preferred embodiment of the present invention provides an automated method of updating the status of clinical research sites in a clinical trial to identify readiness of sites to accept patients. Again, the clinical trial has a plurality of sites which accept patients, and a site is ready to accept patients when it has a status of complete. A site is complete when all milestones for the site are completed. The method operates as follows:

1. The status of the site-based milestones are electronically tracked in a database.
2. A user-interface is provided that allows the status of each site milestone to be modified on a site-by-site basis. One of the modifications is the ability to designate each site milestone as being complete on a site-by-site basis.
3. Upon designating that a site milestone has been completed for a specific site, a processor is used to electronically check whether all of the remaining site milestones for the specific site are completed. If so, it is electronically indicated in the database that the site is complete and thus ready to accept patients.

In the case where the clinical trial has a plurality of sites in multiple countries, and one or more countries have a plurality of country-based milestones, the status of the country-based milestones are electronically tracked in the database. The user-interface allows country-based milestone status for a specific country to be modified. One of the modifications is the ability to designate the country-based milestone as being complete for the specific country. Upon designating that a milestone has been completed for a specific country, the processor is used to electronically check whether all of the remaining milestones for the specific country are completed and all specific milestones for the sites in the country are completed. If so, then it is electronically indicated in the database that the country is complete and thus all sites in the country are ready to accept patients.

In each of the embodiments above, electronic (alert) messages are preferably sent to appropriate pre-designated recipients to instantly inform them when sites and/or countries are ready to accept patients. The electronic messages may be sent in any suitable form, such as emails or text/voice messages. In this manner, the recipients do not need to wait for the next round of report generation to occur to be informed of the site/country completed status.

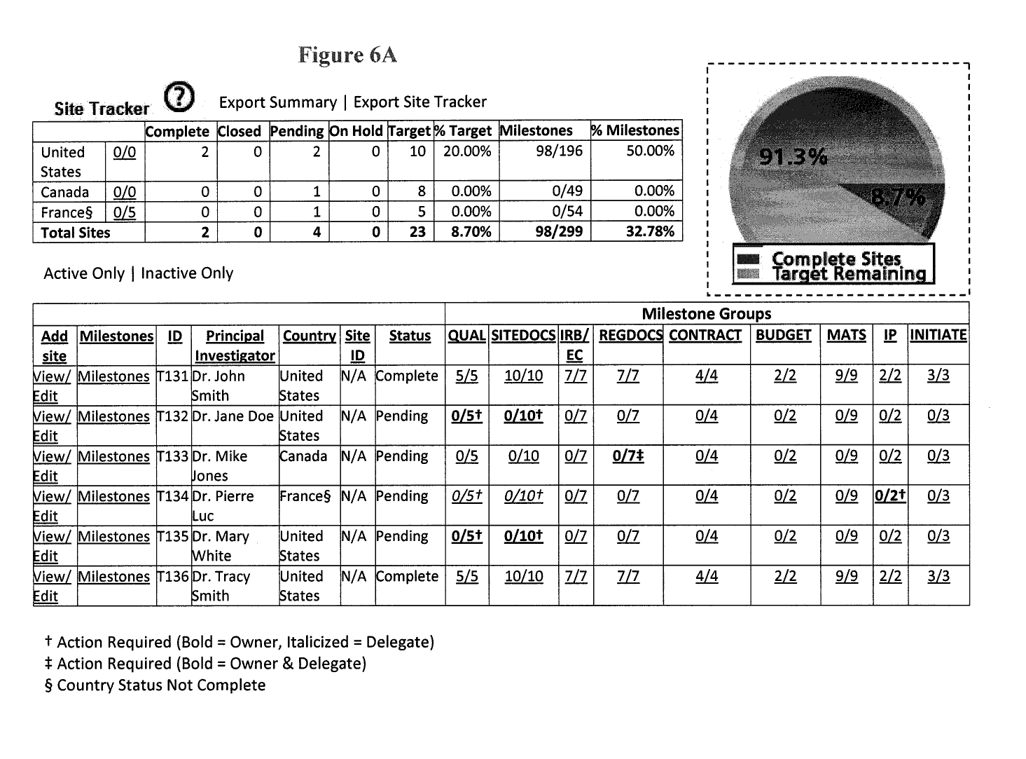

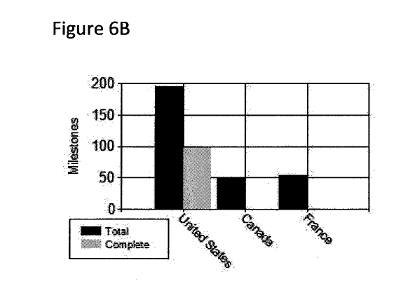

In the preferred embodiment, milestones can be designated as active/inactive on a global level and required/not required on a site-based level. For the system to indicate that a site has achieved a completed status, all of the respective active and required site and country-based milestones need to be completed. If a milestone is designated as “inactive” or “not required,” then it would not be included at all in the count of total milestones shown in the reports, such as the total milestones shown in the denominators of FIG. 6A.

Preferably, only an owner or administrator can change the status of a milestone such as from “pending” to “complete,” and only an administrator can change the active/inactive designation of a milestone.

### II. Detailed Disclosure of System

### 1. System Description

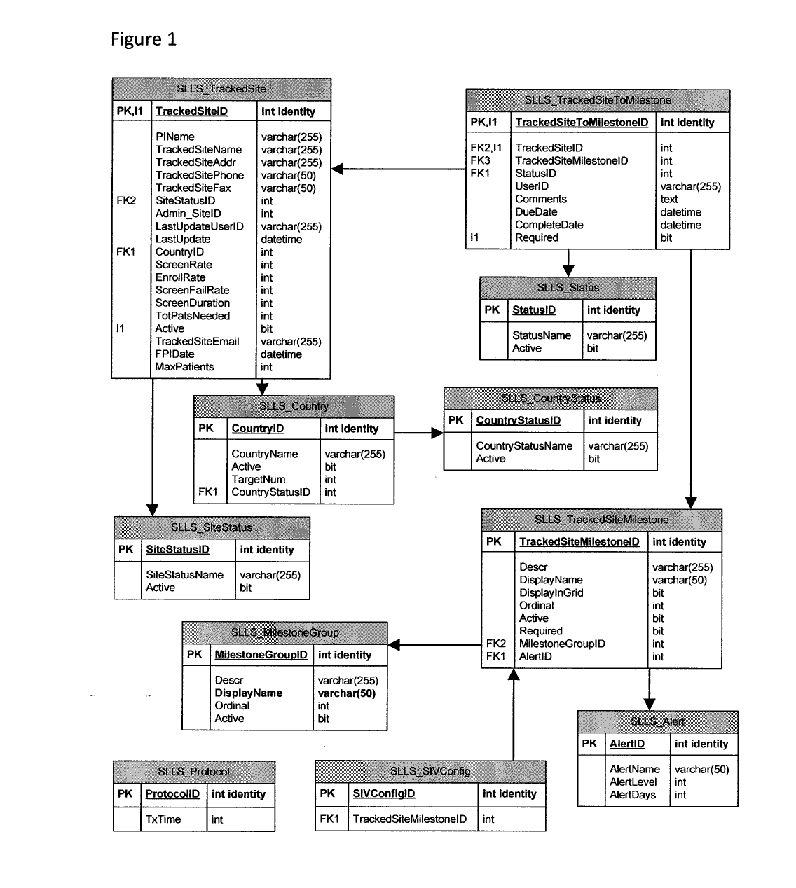

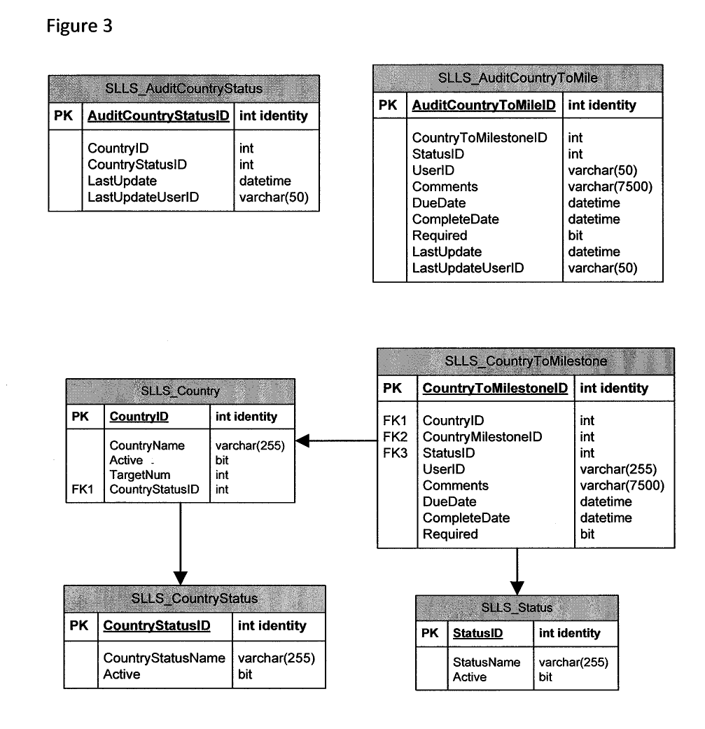

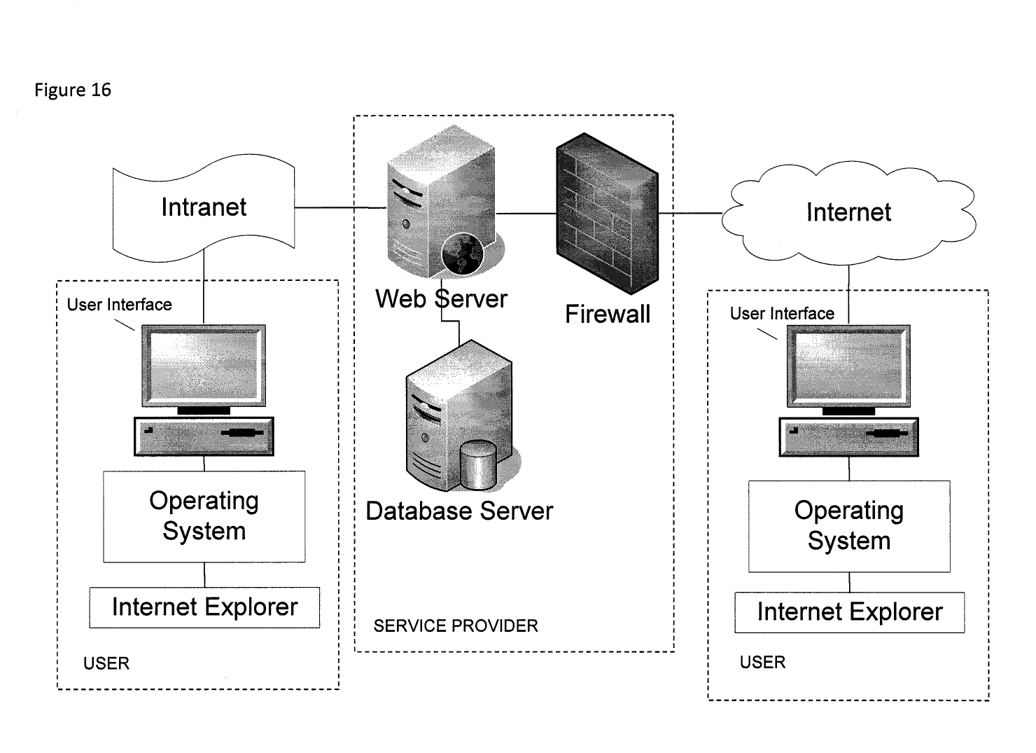

a. The Site Launch Logistics System (SLLS) allows the entire clinical trial team to use a database to track and report the status of the logistics related to the clinical site (site) start-up process for a clinical trial. FIGS. 1-3 show the main database tables used for storing all of the SLLS data.
b. How SLLS is used:
   i. General Contract Project Manager (GCPM)/General Contract Project Associate (GCPA) tailor master list of clinical trial specific milestones
   ii. GCPM/GCPA enters countries and sites into SLLS
   iii. GCPM/GCPA assigns task (milestone) owners and due dates
   iv. Task owners view reports to see their tasks
   v. Task owners update or modify the status of each task
   vi. Summary reports are automatically updated
   vii. Open tasks are easily identified for follow up and drive to closure
   viii. Alert messaging for newly completed sites, items coming due and past due for milestone owners and their manager.
c. Hardware Configuration
   i. FIG. 16 shows one preferred hardware configuration. The database server stores all of the data. The web server (processor) handles all page requests and application processing. The web server (processor) also executes the software code in the Appendix.
   ii. The web server can be exposed to both an Intranet and the Internet. When exposed to the Internet, a firewall is used for security purposes. Client machines must be networked and require an Operating System capable of running Internet Explorer.

### 2. Site Tracker (FIG. 6A)

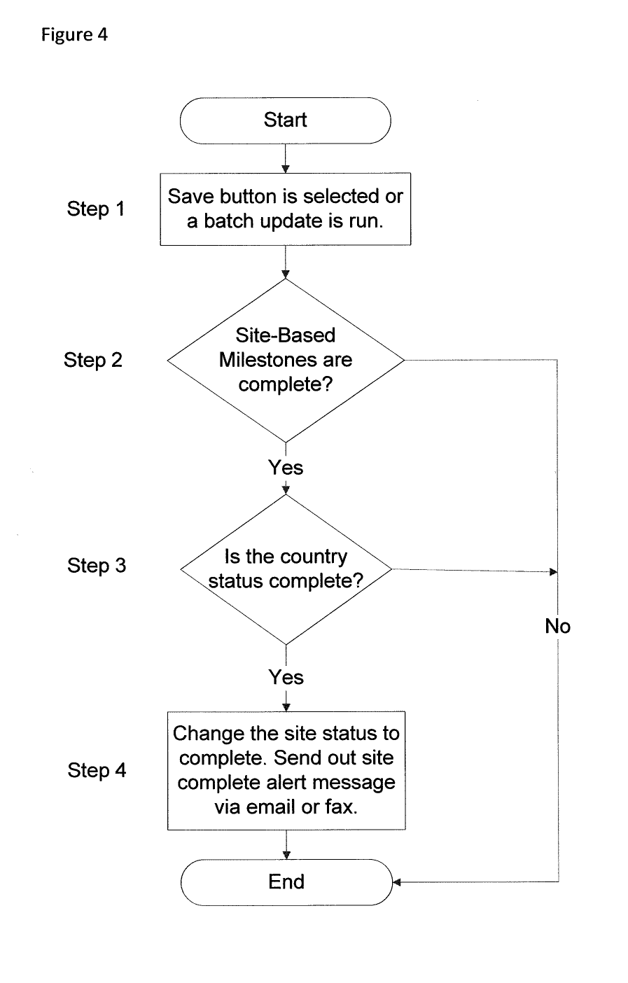

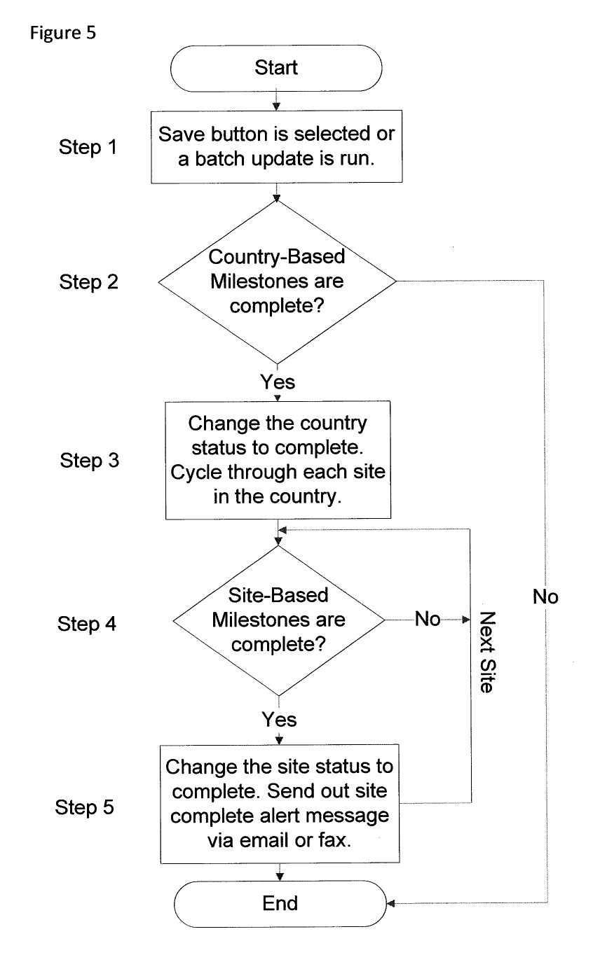

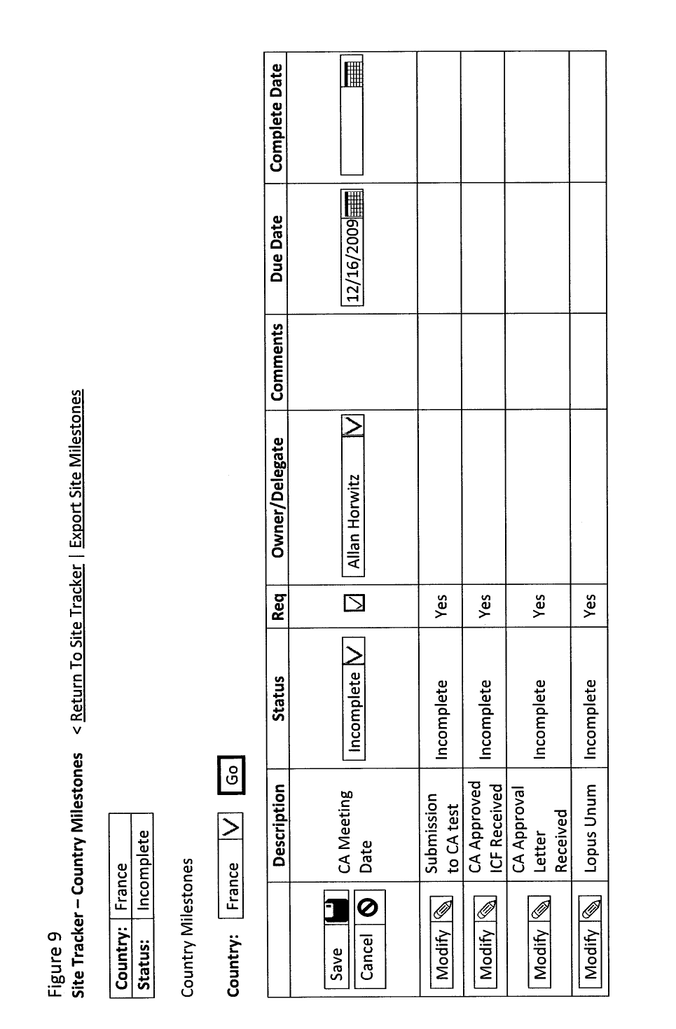

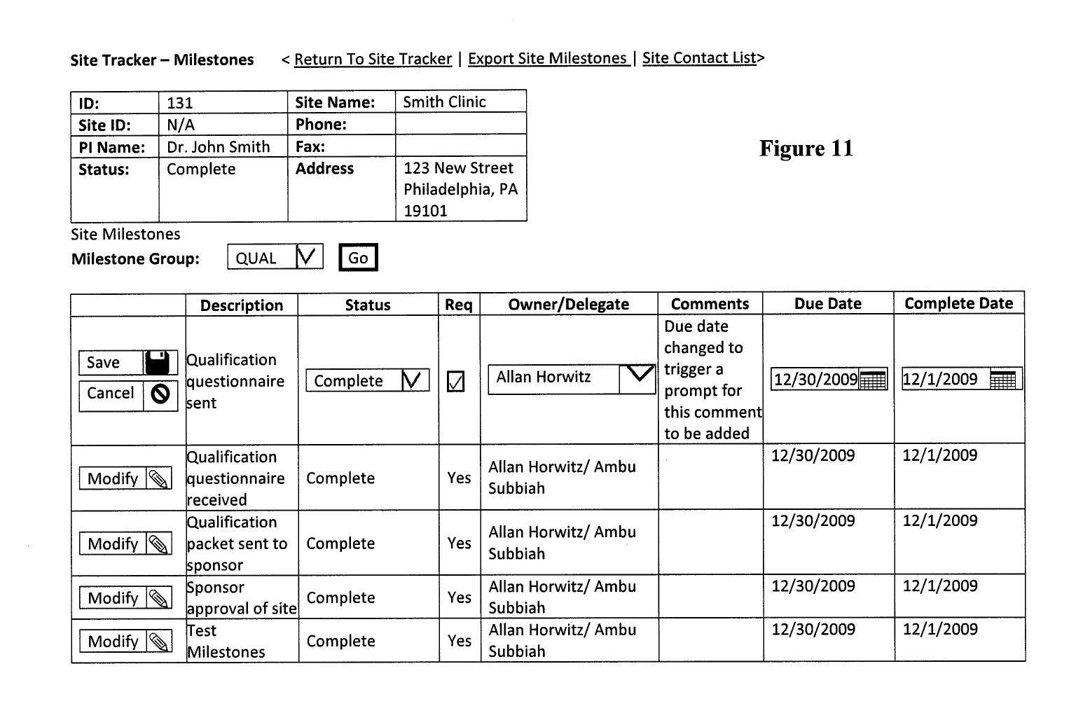

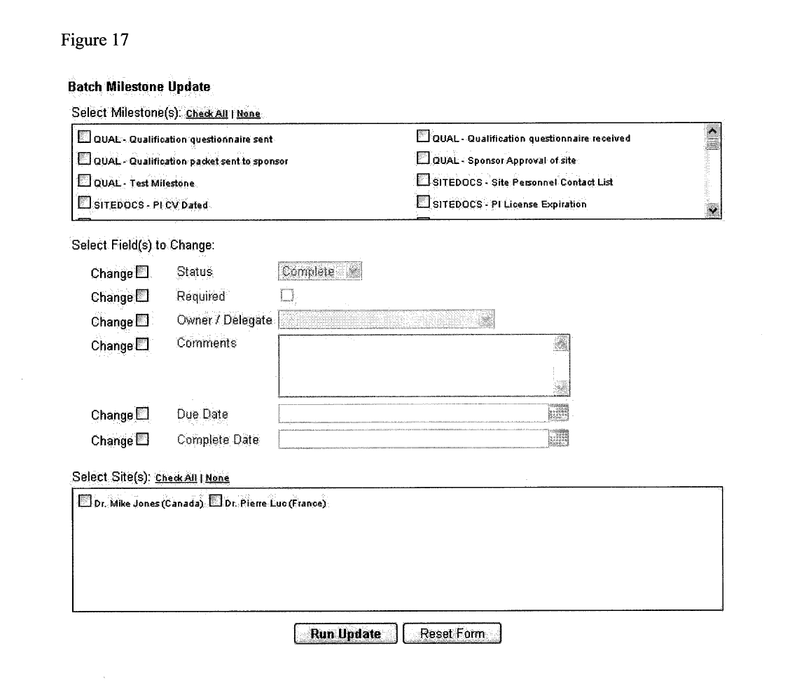

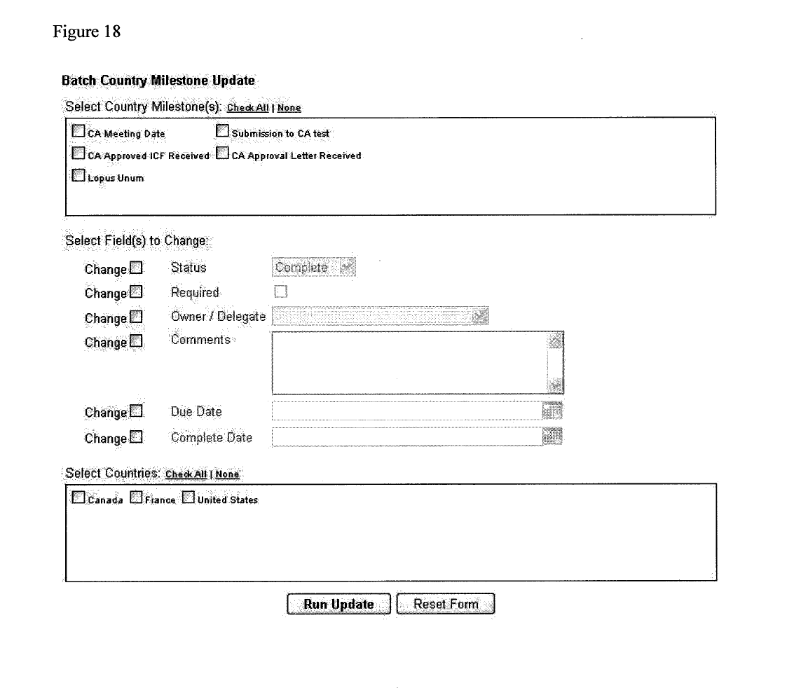

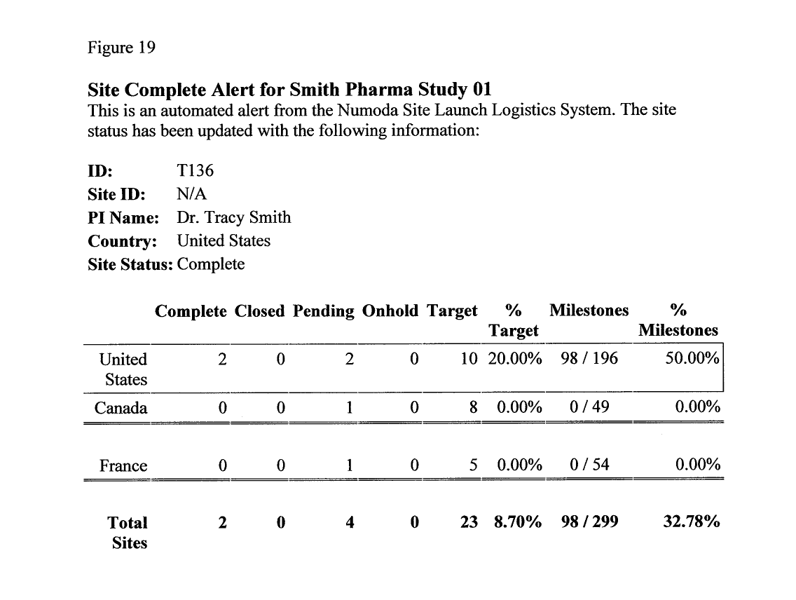

a. Overview
i. The Site Tracker manages the status of clinical research sites in a clinical trial to identify readiness of sites to accept patients. Each site listed has country and site-based milestones associated with them. Each country has country-based milestones associated with them. When every required milestone is completed for both the country and the site, the site status is complete and the site is ready to accept patients, as further illustrated in FIGS. 4 and 5, discussed below.
ii. FIG. 4 is a flowchart that shows the machine process flow once a site-based milestone is saved.
   Step 1—The save button is clicked when modifying a site-based milestone individually. (See FIG. 11) Alternatively, multiple site-based milestones can be modified using a site milestone batch update process. (See FIG. 17)
   Step 2—All required site-based milestones for the clinical site are checked to see if they are completed. If these milestones are not complete, no action is taken. If these milestones are all complete, the system checks to see if the country status is complete.
   Step 3—Check to see if the country that the clinical site is in is complete. If the country status is not complete, no action is taken. If the country status is complete, then the site status is automatically set to complete and the system sends out a site complete alert message.
   Step 4—Site status is set to complete and the site complete alert is sent. (FIG. 19)
iii. FIG. 5 is a flowchart that shows the machine process once a country-based milestone is saved.
   Step 1—The save button is clicked when modifying a country-based milestone individually. (See FIG. 9) Alternatively, multiple country-based milestones can be modified using a country milestone batch update process. (See FIG. 18)
   Step 2—All required country-based milestones for the country are checked to see if they are completed. If these milestones are not complete, no action is taken. If these milestones are all complete, the system updates the country status to complete and then checks the site-based milestones for each site in the given country.
   Step 3—Country status is set to complete and then the system checks the site-based milestones for each clinical site in the given country.
   Step 4—All required site-based milestones for the clinical site are checked to see if they are completed. If these milestones are not complete or the site status is already complete, no action is taken. If these milestones are all complete and the site status is not complete, then the site status is changed to complete and the site complete alert is sent.
   Step 5—Site status is set to complete and the site complete alert is sent. (FIG. 19)

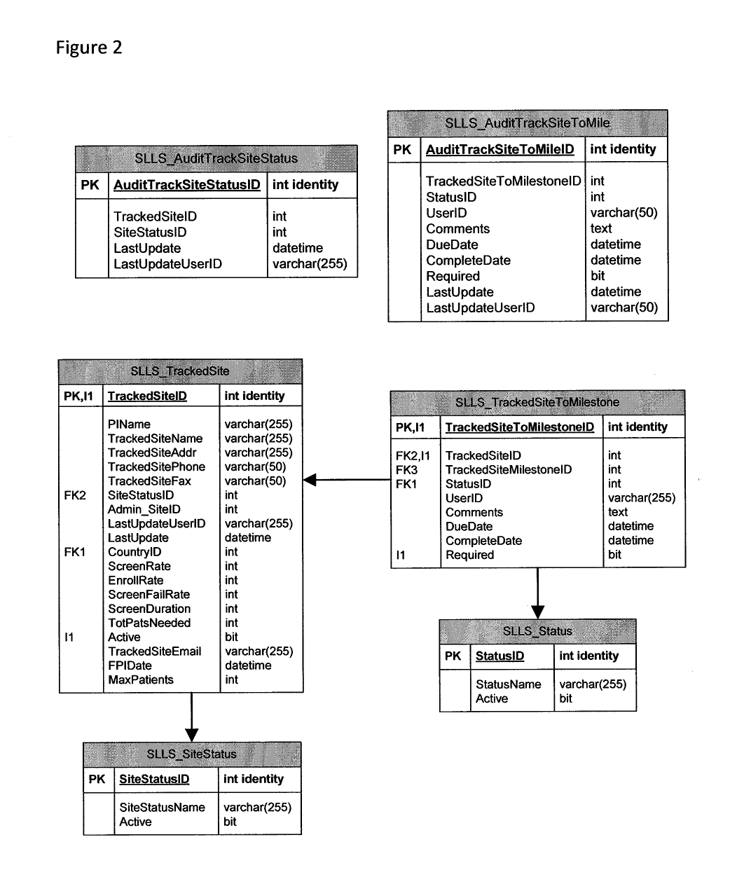

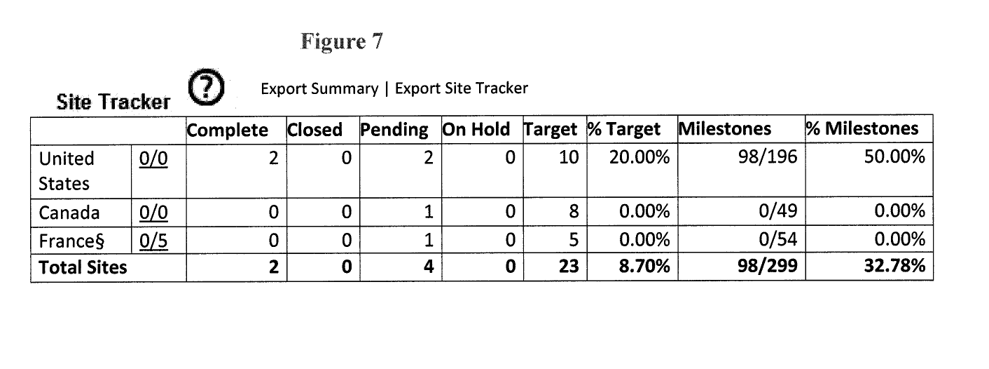

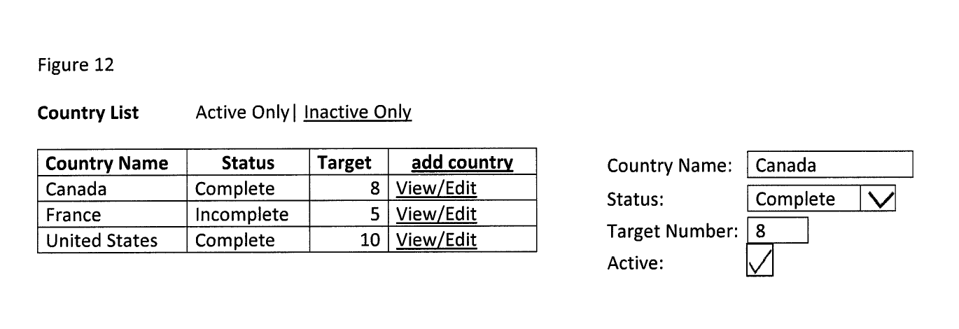

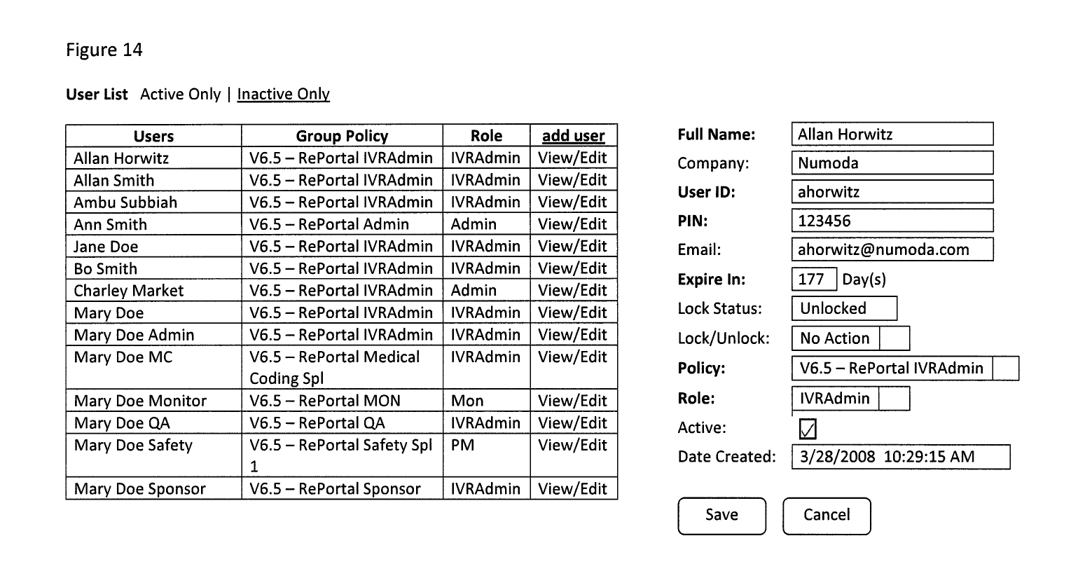

b. Site Status Summary (FIG. 7)
i. Country names are in the first column of FIG. 2. When the required milestones for a given country are completed, the country is considered complete. Incomplete countries are indicated by the section mark (§). Other marks or indicators may be used instead of the section mark.
ii. Countries can be added by SLLS Administrators. SLLS Administrators are controlled by group policies. The group policies are controlled from the User List page. (FIG. 14)
iii. To add countries, click the “Country List” link in the SLLS Administration navigation bar. The Country List (FIG. 12) page lists the currently added countries. Countries can be added by clicking the “add country” link in the grid with the list of countries in it. Countries can be viewed or edited using the “View/Edit” link.
iv. Each country may or may not have required country-based milestones associated with them. A given country's milestones may be modified by clicking on the link in the second column of FIG. 7 (0/5, 4/5, n/n, etc . . . ) next to the country name. FIG. 9 shows the page that the link in the second column leads to. When all required country-based milestones are complete, the country status is then considered complete.
v. Country milestones are tasks that need to be completed for a clinical trial to be legally held in a given country. Until a country status is complete, no sites in a given country can accept patients. If a clinical trial is based in the U.S., usually no country-based milestones are necessary. Country-based milestones are mainly used for foreign countries.
   1. Examples of country-based milestones
      a. CA Meeting Date
      b. Submission to CA test
      c. CA Approved ICF Received
      d. CA Approval Letter Received
      (CA: Certifying Authority; ICF: Informed Consent Form)
vi. Cumulative values are displayed on a country by country basis to identify the current site startup progress for the clinical trial. These values are shown in the 3^{rd}, 4^{th}, 5^{th} and 6^{th} columns of FIG. 7, “Complete”, “Closed”, “Pending” and “On Hold” respectively. Each column displays the total sites with a given site status. Site statuses can be Complete, Closed, Pending and On Hold. “Closed” means that a site is no longer a potential candidate for the study for any number of reasons. “Pending” means the site is still a potential candidate and there is at least one uncompleted site-based milestone. “On Hold” means that a decision is pending on whether to use the site in the study and no activity is occurring towards completing any milestones (previous activity may have occurred resulting in completion of certain milestones). In the disclosed embodiment, milestones associated with closed and on hold sites are included in the total number of milestones shown in the reports, such as the total milestones shown in the denominators of FIG. 6A. If such milestones are not desired to be included in the total milestones, the site can be designated as being “inactive” as discussed above. In an alternative embodiment, the milestones of closed and on hold sites may be excluded from the total number of milestones shown in the reports even if the status of the site is still “active.” vii. The target column is the target number of completed sites for a given country. Target values are entered when countries are added to a clinical trial.
viii. The last three columns of FIG. 7 display calculated values in the percentage of completed sites to the target number of sites, the cumulative number of both country and site-based milestones, and a percentage of completed milestones for the cumulative number of both country and site-based milestones.
ix. Code snippets for creating the Site Status Summary are in Parts 1, 4 and 5 of the Appendix.

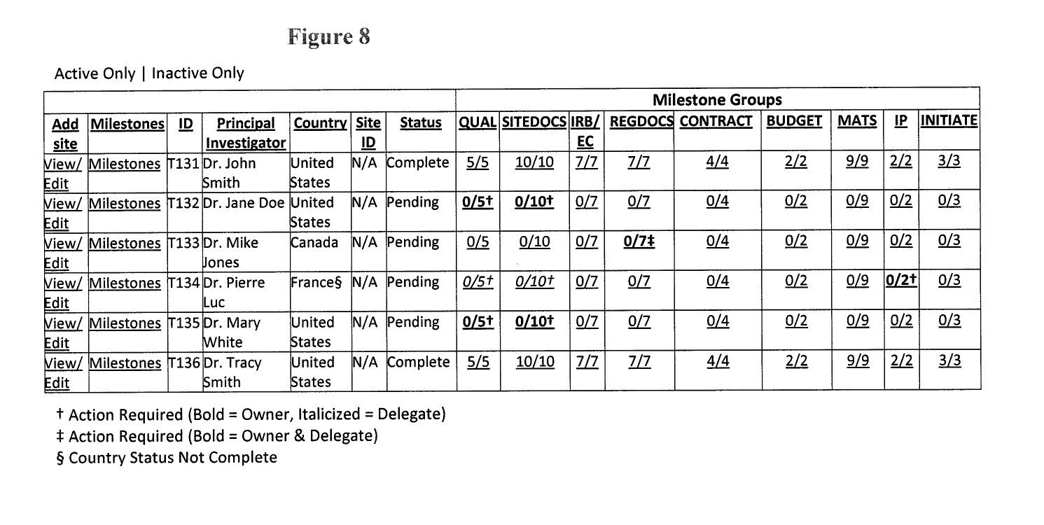

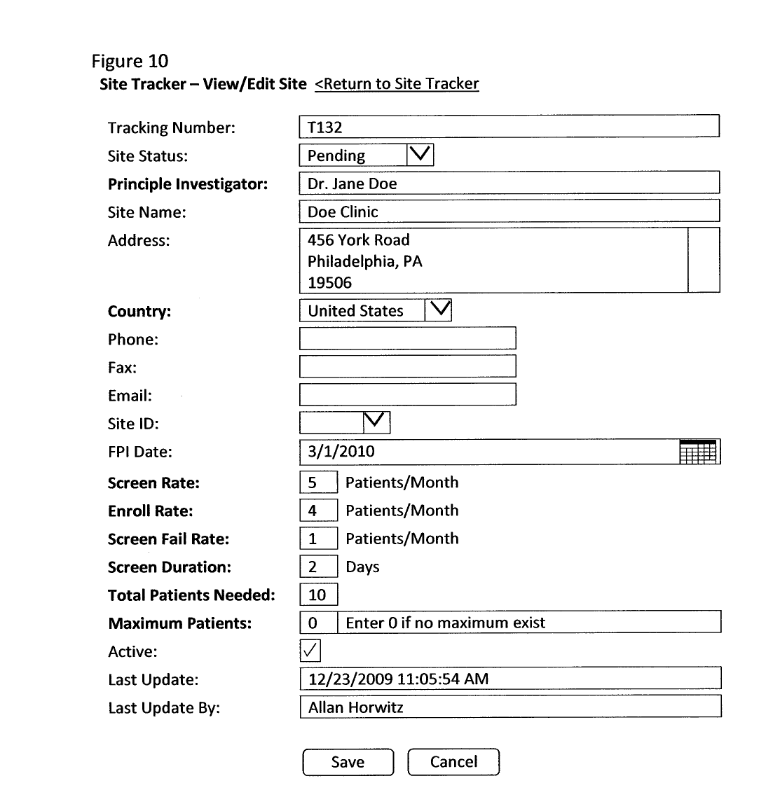

c. Site Tracker Summary (FIG. 8)
i. All sites for the clinical trial are listed in this summary grid.
ii. Sites can be added to the system by clicking the “add site” link in the top left cell of the summary grid. (FIG. 10)
iii. Viewing and editing sites can be done by clicking the “View/Edit” link in the first column of FIG. 8.
iv. Each site will have one Principal Investigator (PI) associated with it.
v. Active and Inactive Filters
   1. The list of sites can be filtered by Active Only or Inactive Only. A site can be designated as Active or Inactive on the View/Edit Site page. When the list of sites is filtered by “Active Only”, which is the default, only active sites are shown. This active field is different from the site status. Active and Inactive are ways to remove items from the program without actually deleting the items from the program for any potential future auditing. Filtering by Inactive Only will only list inactive sites.
vi. Some features are only available to SLLS Administrators. SLLS Administrators are controlled by group policies.
   1. Admin Only Features
      a. Add/View/Edit Sites
      b. Active and Inactive filters
vii. Milestones for a given site can be viewed and modified, depending on a user's rights, using either the “Milestones” link in the second column of FIG. 7 or a link in a milestone group column (0/5, 4/5, mm, etc . . . ). (FIG. 11)
viii. There are nine designated Milestone Group columns. Each group contains required milestones for a given site. The purpose of the groups is to organize the numerous site-based milestones, thereby easing management of the overall site setup process.
ix. Click on the link in the milestone group column to go directly to a given milestone group.
x. Milestone Groups—Header Definitions and Associated Milestones

| Milestone Group | Milestones in the milestone group |
|---|---|
| QUAL | Qualification questionnaire sent |
| | Qualification questionnaire received |
| | Qualification packet sent to sponsor |
| | Sponsor Approval of site |
| | Site Type (Academic, Hospital, Other) |
| SITEDOCS | Confidentiality Agreement Received |
| | Site Personnel Contact List |
| | PI CV Dated |
| | PI License Expiration |
| | Sub-I(s) CV Received (list all) |
| | Sub-I(s) License(s) Expiration (list all) |
| | Financial Disclosure(s) for PI |
| | Financial Disclosure(s) for Sub-I(s) (list all) |
| | W-9 Form Received |
| | Credentialing Done |
| IRB/EC | IRB/EC Type (central/local) |
| | Central IRB/EC questionnaire |
| | IRB/EC Membership Committee List |
| | Submission to IRB |
| | IRB/EC Meeting Date |
| | IRB/EC Approved ICF Received |
| | IRB/EC Approval Letter Received |
| REGDOCS | Regulatory Documents Sent to Site |
| | Protocol Signature Page |
| | Protocol Amendment Signature Page (list all) |
| | Form FDA 483 with response (if applicable) |
| | FDA Form 1572 Signature Date |
| | Regulatory Documents Rec'd from Site |
| | TOROs received from site (if applicable) |
| CONTRACT | Site Source (Numoda, Sponsor, CRO) |
| | Site is a Key Opinion Leader |
| | Contract template sent to Site |
| | Fully Executed Contract |
| BUDGET | Template budget sent to Site |
| | Final budget negotiated |
| MATS | Central Reading Center Certification (if applicable) |
| | Site Technical Assessment completed |
| | Calibrated refrigerator/freezer available for study drug |
| | (if applicable) |
| | Pentab Certification |
| | Pentab Sent |
| | Pentab Chain of Custody completed |
| | ECG/Equipment is calibrated (if applicable) |
| | ECG Machine Sent (if applicable) |
| | Lab Kits Sent (if applicable) |
| IP | Final drug available for shipment to sites |
| | Drug available at site |
| INITIATE | SIV Date - (Due Date = Scheduled SIV Date, |
| | Comp. Date = Confirmed SIV Date) |
| | New SIV Field (Amendment 1) |

i. Milestone Group—Explanation of acronyms/abbreviations
   1. QUAL: Site Qualification
   2. CONTRACT: Site Contracting
   3. SITEDOCS: Site Documentation
   4. BUDGET: Site Budgeting
   5. MATS: Site Materials
   6. IRB/EC: IRB/EC Documentation (IRB: Institutional Review Board; EC: Ethics Committee)
   7. IP: Study Drug
   8. REGDOCS: Regulatory Documentation
   9. INITIATE: Site Initiation
ii. Milestones in the Milestone Group—Explanation of acronyms/abbreviations
   PI: Principal Investigator
   CV: curriculum vitae
   IRB/EC: IRB: Institutional Review Board; EC: ethics committee
   CRO: clinical research organization
   SIV: site initiation visit
iii. If there are any required milestones assigned to the user currently logged in, the Site Tracker will indicate where action is required by site and by milestone group. See the legend on FIG. 6A for more detail. In the preferred embodiment, colors and daggers are used as indicators. In FIG. 6A, bolding was substituted for a yellow color, and italics was substituted for an orange color since the figures are not presented in color. Other marks or indicators may be used instead of colors or daggers.
iv. Columns can be sorted by clicking on the headers.
v. Code snippets for creating the Site Tracker Summary are in Parts 2-5 of the Appendix.

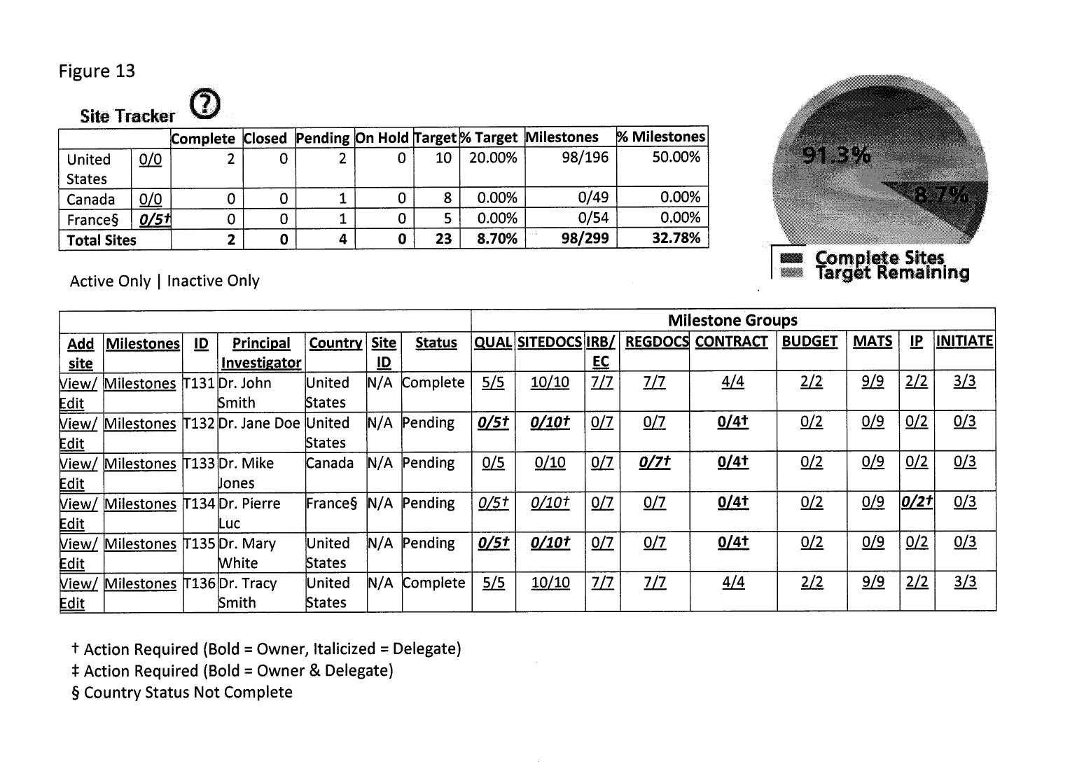

d. Site Tracker—Action Required Feature
The Site Tracker page (FIG. 6A) will be formatted according to what action is required from the currently logged in user. For example, in FIG. 6A, the logged in user is the owner of site-based milestones that need to be completed. The areas that require action are indicated by both bold/italicized text and icons. Indicators will differ if the logged in user is an owner or delegate for any incomplete milestones. The same Site Tracker page in FIG. 6A is shown for a different logged in user in FIG. 13. Both FIGS. 6A and 13 are snapshots for the same clinical trial. The only difference is in the logged in user.

e. Other Site Tracker Features
i. There is a help popup (not shown) with information regarding milestone group definitions.
ii. There is a rotating content area indicated by the dashed box in FIG. 6A. The content rotates between a pie chart showing overall progress with complete vs. target sites (see FIG. 6A) and a column chart showing milestone progress, complete vs. total required (see FIG. 6B).
iii. Both the Site Status Summary and the Site Tracker Summary grids can be exported to Microsoft Excel®.
iv. Sorting on the Site Tracker Summary grid can be done by clicking on the column header.
v. When all required milestones for a site and its respective country are complete, or all the site-based milestones are complete and the country status is complete, the site will automatically be set to complete and site complete alerts will be sent to designated recipients.
vi. Countries will be set to complete when all required country-based milestones are completed.

f. Site and Country-Based Batch Milestone Updates
i. The site-based milestone values such as status, required, owner, comments, due date and complete date can be updated on a site by site basis using the milestone batch update form (see FIG. 17). This form will allow updates to be made for any combination of site-based milestones, milestone values and clinical sites.
ii. The country-based milestone values such as status, required, owner, comments, due date and complete date can be updated on a country by country basis using the country milestone batch update form (see FIG. 18). This form will allow updates to be made for any combination of country-based milestones, milestone values and countries.
iii. Whenever a batch update is performed, the flowchart process in FIGS. 4 and 5 is executed, as shown in Step 1 of FIGS. 4 and 5.

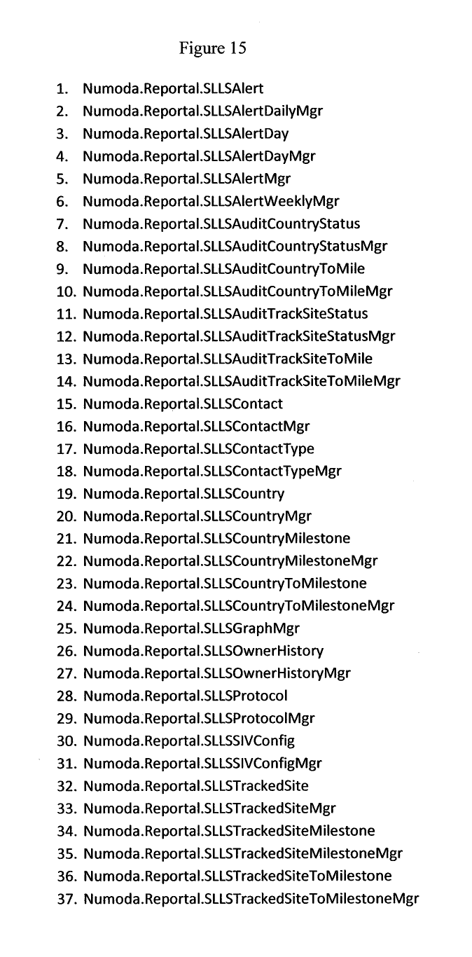

g. Software Code in the Appendix
i. This implementation is done using ASP.Net and a C# DLL (NumodaDLL). The main system processes are done in the NumodaDLL.
ii. A full list of the SLLS Classes in the NumodaDLL is shown in FIG. 15.
iii. Site Status Summary sample code is shown in Parts 1, 4 and 5 of the Appendix.
iv. Site Tracker Summary sample code is shown in Parts 2-5 of the Appendix.

The Appendix provides software code for implementing one preferred embodiment of the present invention shown in the figures and described above. However, the scope of the present invention is not limited to this particular implementation of the invention.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer readable media. The media is encoded with computer readable program code for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

While the present invention has been particularly shown and described with reference to one preferred embodiment thereof, it will be understood by those skilled in the art that various alterations in form and detail may be made therein without departing from the spirit and scope of the present invention.

What is claimed is:

1. An automated method of generating a displayable report of the status of clinical research sites in a clinical trial to identify readiness of sites to accept patients, the clinical trial having a plurality of sites in multiple countries which accept patients, the method comprising:
(a) providing a plurality of electronically tracked site-based milestones and separate country-based milestones for preparing sites to be ready to accept patients for the clinical trial, wherein each site is associated with a country;
(b) electronically tracking the status of the site-based milestones and country-based milestones in a database, wherein the site-based milestones and the country-based milestones are tracked separately from each other; and
(c) automatically generating in a processor a displayable report of the status of the electronically tracked country-based milestones on a country-by-country basis and site based milestones, wherein the report separately identifies the status of the country-based milestones and the site-based milestones.

2. The method of claim 1 wherein step (a) further comprises providing a plurality of site-based milestone groups, and each site-based milestone is categorized into one of the plurality of milestone groups.

3. The method of claim 2 wherein milestones in each milestone group have closely related functions.

4. The method of claim 1 further comprising:
(d) electronically tracking a country status for each country that has at least one site in the clinical trial, the country status being either complete or incomplete, the country status being complete if all of the respective country-based milestones are completed.

5. The method of claim 1 further comprising:
(d) electronically tracking a site status for each site, the site status being one of complete, closed, pending, and on hold, the site status being complete if all of the respective site-based milestones and the respective country-based milestones are completed.

6. The method of claim 1 further comprising:
(d) electronically tracking a site status for each site, the site status including a status of being complete, the site status being complete if all of the respective site-based milestones and the respective country-based milestones are completed.

7. An automated method of generating a displayable report of the status of clinical research sites in a clinical trial to identify readiness of sites to accept patients, the clinical trial having a plurality of sites which accept patients, the method comprising:
(a) providing a plurality of electronically tracked site-based milestones for preparing sites to be ready to accept patients and a plurality of site-based milestone groups for the clinical trial, each site-based milestone being categorized into one of the plurality of milestone groups, wherein each site is associated with a country;
(b) electronically tracking the status of the site-based milestones in a database; and
(c) automatically generating in a processor a displayable report of the status of the electronically tracked site-based milestones and site-based milestone groups, wherein the report separately identifies the status of the site-based milestones and the site-based milestone groups.

8. The method of claim 7 wherein milestones in each milestone group have closely related functions.

9. The method of claim 7 wherein each milestone is assigned to one of a plurality of owners, each owner having unique login credentials for viewing a display of the status of clinical research sites and generating the report in step (c), wherein each milestone includes a status of being complete, the method further comprising:
(d) identifying using the processor the logged in owner based on entered login credentials; and
(e) identifying using the processor site-based milestone groups that have milestones with a status of not being complete,
wherein the report generated in step (c) further includes an identifier associated with any milestone groups that have milestones with a status of not being complete for the logged in owner.

10. A computer program product for generating a displayable report of the status of clinical research sites in a clinical trial to identify readiness of sites to accept patients, the clinical trial having a plurality of sites in multiple countries which accept patients, the computer program product comprising computer-readable media encoded with instructions for execution by a processor to perform a method comprising:
(a) providing a plurality of electronically tracked site-based milestones and separate country-based milestones for preparing sites to be ready to accept patients for the clinical trial, wherein each site is associated with a country;
(b) electronically tracking the status of the site-based milestones and country-based milestones in a database, wherein the site-based milestones and the country-based milestones are tracked separately from each other; and
(c) automatically generating a displayable report of the status of the electronically tracked country-based milestones on a country-by-country basis and site based milestones, wherein the report separately identifies the status of the country-based milestones and the site-based milestones.

11. The computer program product of claim 10 wherein step (a) further comprises providing a plurality of site-based milestone groups, and each site-based milestone is categorized into one of the plurality of milestone groups.

12. The computer program product of claim 11 wherein milestones in each milestone group have closely related functions.

13. The computer program product of claim 10 wherein the computer-readable media is encoded with instructions for execution by the processor to perform a method further comprising:
(d) electronically tracking a country status for each country that has at least one site in the clinical trial, the country status being either complete or incomplete, the country status being complete if all of the respective country-based milestones are completed.

14. The computer program product of claim 10 wherein the computer-readable media is encoded with instructions for execution by the processor to perform a method further comprising:
(d) electronically tracking a site status for each site, the site status being one of complete, closed, pending, and on hold, the site status being complete if all of the respective site-based milestones and the respective country-based milestones are completed.

15. The computer program product of claim 10 wherein the computer-readable media is encoded with instructions for execution by the processor to perform a method further comprising:
(d) electronically tracking a site status for each site, the site status including a status of being complete, the site status being complete if all of the respective site-based milestones and the respective country-based milestones are completed.

16. The method of claim 1 wherein the displayable report is formatted to be presented on a single display screen.

17. The method of claim 7 wherein the displayable report is formatted to be presented on a single display screen.

18. The computer program product of claim 10 wherein the displayable report is formatted to be presented on a single display screen.

19. The method of claim 1 wherein the status of the country-based milestones is presented in the report in numerical form by showing the number of completed country-based milestones compared to the total number of existing country-based milestones.

20. The method of claim 7 wherein the status of the site-based milestone groups is presented in the report in numerical form by showing the number of completed site-based milestone groups compared to the total number of existing site-based milestone groups.
